(19) United States
(12) Patent Application Publication
(10) Pub. No.: US 2003/0033914 A1
(43) Pub. Date: Feb. 20, 2003

(54) Perforating device for sheet-like materials

(76) Inventors: Michael Mutchnik, Verdun (CA); Lou Appel, Montreal (CA)

Correspondence Address: Michael MUTCHNIK, 17 De La Poudriere app. 105, Verdun, QC, H4G 3J5, CA

(21) Appl. No.: 09/933,082

(22) Filed: Aug. 20, 2001

(51) Int. Cl. B26D 7/06

(52) U.S. Cl. 83/23; 83/78; 83/346; 83/660

(57) ABSTRACT

A perforating device for production of a plurality of an apertures in a sheet-like material, each aperture has an opening and a rearwardly folded flap which adjoins a rear zone of the opening. The device comprises a frame from two supporting means spaced on both sides of the drawing material, an anvil roller with a cylindrical outer surface extending substantially the full width across the sheet-like material. A plurality of circumferential grooves dispose along this surface for transiently receiving flaps into. The continuously drawing material partially encircles the outer surface at any time to provide to the anvil roller the same speed. A perforating roller matching the anvil roller at any time for maintaining the same speed, includes a plurality of an adjustable perforating means radially protruding from the same and provides the apertures in the partially encircling continuously drawing between both rollers sheet-like material with simultaneous flaps deflecting from openings into grooves. A folding means extending substantially the full width across a part of the drawing material outdrawing from rollers for an irrevocable rearward folding of the deflecting flaps.

### FIELD OF THE INVENTION

The present invention relates to a perforating device and more particularly to a device for continuously forming in a sheet-like materials a plurality of openings with a rearwardly folded flap adjoining a rear zone of the same.

### BACKGROUND OF THE INVENTION

In the industry it is frequent practice to perform perforating operation in a sheet materials for to provide a holes or apertures in, for example, a different types of a paper for serving a various purposes. Usually in the prior art is used a sharpened to a point pin which pierced the paper.

The limitation of this prior art is that the holes or apertures performed in the paper by this operation have a plurality of a peripheral flapping pieces which at least partially and very often fully closed this holes or apertures. It makes it impossible to use that perforating paper in a production processes using air permeability of this perforating paper.

Good example of the production process which needs a guaranty opened holes in the perforating paper is a fabric process. The stack of fabric is held in place by suction acting on the bottom layer of the stack. The fabric is air permeable so that the suction is experienced by all of the layers of the stack. The paper is not substantially air permeable. To be more air permeable it is perforated to provide openings for passage of air through the paper. A backing of the perforated paper is applied to each layer of fabric to provide a uniform air permeability for all types of fabric so that the same suction can be applied to hold the fabric during the fabric cutting processing.

There are various known techniques for producing perforated sheet material, such as by completely cutting out areas and removing these areas to form the perforations or by partially cutting portions and bending these partially cut portions back to form a flap adjoining an aperture.

All of these prior art perforated sheet materials have their various disadvantages. The first technique is slow and produces a large amount of the perforations (debris). The flaps forming by the second technique very often fold back and close up the aperture, and hence, reduced or even close desired permeability of the sheet material.

U.S. Pat. No. 5,151,077 issued to Cole, Jr. on Sep. 29, 1992 disclosed apparatus for perforating paper, which has a perforating teeth sharpened to a point in their upper portion for performing a triangular opening in the paper formed by piercing into and tearing in the plan the paper because the perforating teeth move at a slower speed than the paper.

The principal problems associated with this apparatus are difficulties and even impossibilities to keep both these actions in a constant condition and as a result the apertures in the paper are very variable in their dimensions and shapes and might vary from almost unopened to the grand tearing holes. Even in the rear moments when both these actions are kept in a constant condition, the tearing caused goffered flaps. Their flaps are folded not only from their attachments to the apertures, but also from differently disposed goffers. Also the goffered flap aspires into a straight position and additionally closed the opening.

### OBJECTS OF THE INVENTION

An object of the present invention is to provide a perforating device for sheet materials that obviates the above mentioned disadvantages.

Another object of the present invention is to provide a perforating device which performs a plurality of an apertures having a uniform shape size.

Other object of the present invention is to provide a perforating device which performs the aperture with a flap remaining on and being rearwardly folded from a rear end of the aperture.

A further object of the present invention is to provide a device which is easy to establish for perforating continuously drawing sheet-like materials.

Still another object of the present invention is to provide a perforating device which is inexpensive.

Still a further object of the present invention is to provide a perforating device which can be used for providing constantly shaped apertures in a different sheet-like materials.

Other objects and advantages of the present invention will become apparent from a careful reading of the detailed description provided herein, within appropriate reference to the accompanying drawings.

### SUMMARY OF THE INVENTION

According to one aspect of the present invention, there is provided a perforating device for production a plurality of apertures in a sheet-like material, said material continuously drawing through the device from a supply means to a packaging means, each of the apertures has an opening and a flap adjoining a rear zone of the opening and rearwardly folded from the same. For be adjustably established the device comprises a frame which includes two supporting means spaced on both sides of the drawing material. The perforating device has an anvil roller with a cylindrical outer surface extending substantially the full width across the sheet-like material and a plurality of circumferential grooves disposed along the surface and allowed transiently receiving flaps into, the anvil roller freely rotating about its longitudinal axle, and is connected to the supporting means, the continuously drawing material partially encircled the outer surface at any time to provide to the anvil roller the same speed by virtue of friction developed between them; a perforating roller which includes a plurality of an adjustable perforating means radially protruding from the same to provide the apertures in the partially encircling continuously drawing between these rollers sheet-like material, usually from border to border of the same, with simultaneous deflecting of the flaps from the openings into the grooves, the perforating roller freely rotating about its longitudinal axle is connected to the supporting means and matching the anvil roller at any time for maintaining the same speed as the anvil roller; a folding means extending substantially the full width across a part of the drawing material outdrawing from the rollers into the packaging means and being adjustably connected to the frame for irrevocable rearwardly folding said deflecting flaps.

Preferably, at least one of the perforating means is at any time in engagement with a portion of the material partially encircling the outer surface of the anvil roller, the perforating means has a free peripherally closed cutting edge adapted for jointly with the groves cuttingly penetrating the material by a front and a both lateral sides of the edge for developing openings and deflectingly pushing flaps by a rear side of the same from the openings into the grooves.

Preferably, both rollers have an axle journals integral to the rollers, freely rotated into said supporting means and having a free ends protruding from an external surfaces of supporting means, each of free ends has a gearing means mutually engaging a neighbor gearing means for providing said matching between rollers.

Preferably, at least one of rollers is adjustably connected to the supporting means via a pivoting means, each supporting means has an adjuster for controlling the mutually engaging and allowed to separate rollers for inserting the sheet-like material between them in the beginning of the perforating process.

Preferably, the adjuster is a pneumatic cylinder.

Preferably, the perforating means are adjustably twisted in the perforating roller via mutual male and female threads.

Preferably, the folding means includes at least one longitudinal brush extending substantially the full width across the outdrawing material.

Preferably, the folding means includes at least one longitudinal electrical heater extending substantially the full width across the outdrawing material.

Preferably, the frame includes a directing means extending substantially the full width across the material located between the supply means and the anvil roller for stabilizing dimension of the partially encircling.

Preferably, the directing means is a freely rotating cylindrical roller.

According to the second aspect of the present invention, there is provided a method for production a plurality of apertures in a sheet-like material, continuously drawing from a supply means to a packaging means through a perforating device extending substantially the full width across the material, each of the apertures has an opening and a flap adjoining a rear zone of the opening and rearwardly folded from the same. The method comprises the steps of:

a) partially encircling an outer surface of an anvil roller by the continuously drawing material at any time, the anvil roller has a cylindrical outer surface extending substantially the full width across the sheet-like material and a plurality of circumferential grooves disposed along this surface which allowed transiently receiving the flaps into, the anvil roller freely rotating about its longitudinal axle and is connected to supporting means spaced on a both sides of the drawing material, both supporting means forming a frame allowed to adjustably establish said device;

b) providing to the anvil roller same speed as the continuously drawing partially encircling the outer surface material by virtue of friction developed between them;

c) matching the anvil roller with a perforating roller for maintaining by the perforating roller the same speed as the anvil roller at any time, the perforating roller includes a plurality of an adjustable perforating means radially protruding from the same, at least one of the perforating means is at any time in engagement with a portion of the material partially encircling the outer surface of the anvil roller;

d) providing the apertures in the partially encircling continuously drawing between rollers sheet-like material, usually from border to border of the same, with simultaneous flaps deflecting from the openings into the grooves, the perforating roller freely rotating about its longitudinal axle and is connected to the supporting means;

e) folding the deflecting flaps rearwardly and irrevocably by folding means extending substantially the full width across a part of the drawing material outdrawing from rollers into the packaging means.

### BRIEF DESCRIPTION OF THE DRAWINGS

In the annexed drawings, like reference characters indicate like elements throughout.

FIG. 1 is a schematic side view of the perforating device of the present invention;

FIGS. 2 and 2a are an enlarged partial longitudinal section view of a portions of a performed perforated sheet-like material shown in FIG. 1 taken in portions 2 and 2a;

FIG. 3 is a side view taken along line 3-3 of FIG. 1; and

FIG. 4 is a partial longitudinal section view taken in portion 4 of FIG. 1.

### DETAILED DESCRIPTION OF THE PREFERRED EMBODIMENTS

With reference to the annexed drawings the preferred embodiments of the present invention will be herein described for indicative purpose and by no means as of limitation.

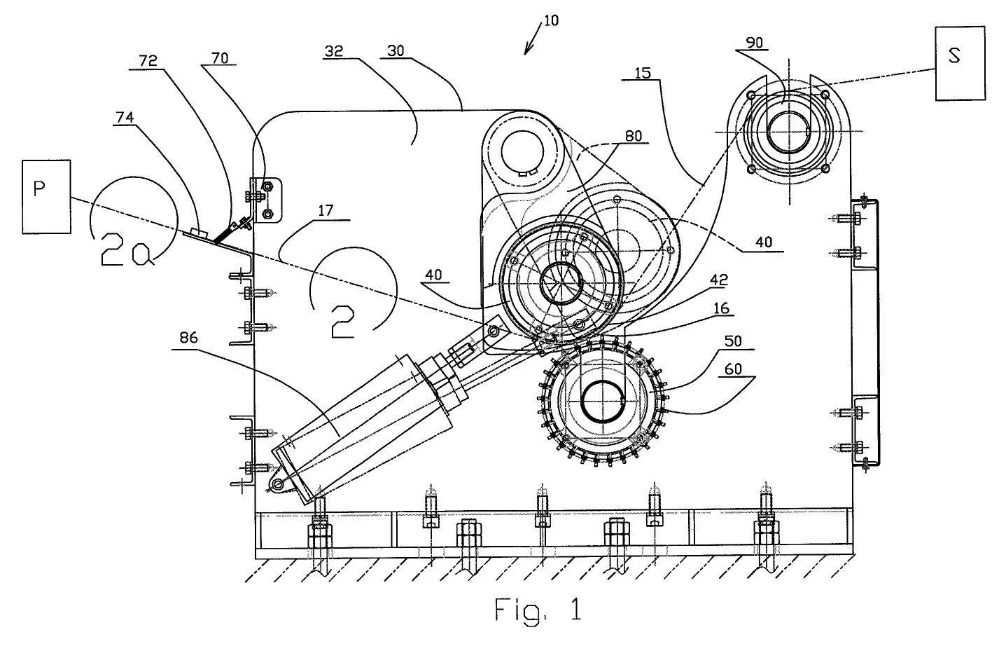

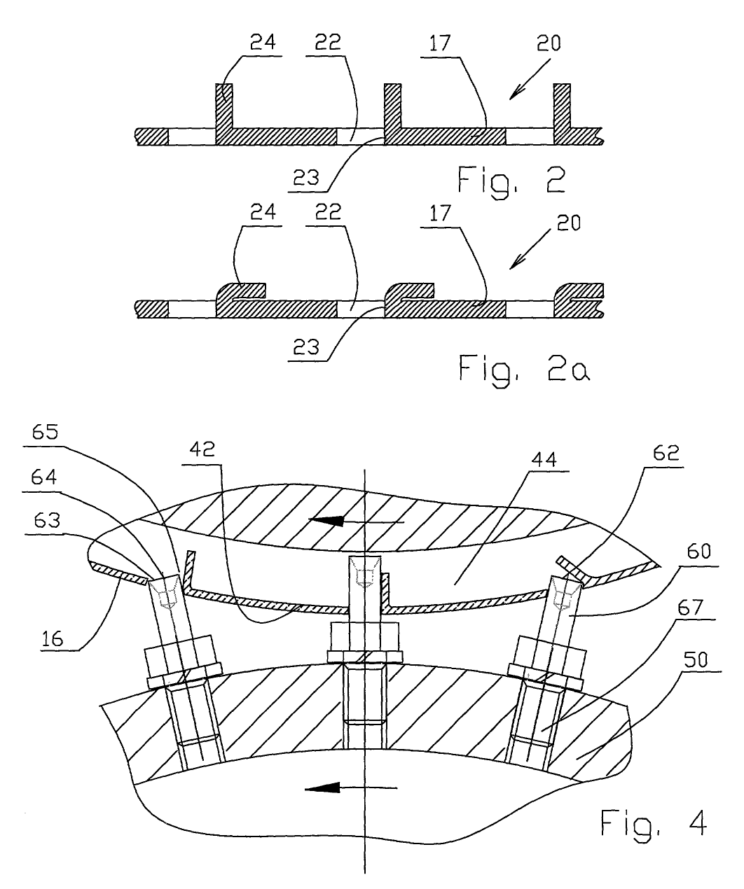

The present invention is carried into practice by passing the sheet-like material to be perforated through the perforating device 10. With reference to FIGS. 1-4 there is illustrated a perforating device 10 for production a plurality of an apertures 20 in a sheet-like material 15. The material 15 continuously drawing through the device 10 from a supply means S to a packaging means P. Each of the apertures 20 has an opening 22 and a flap 24 adjoining a rear zone 23 of the opening 22 and being rearwardly folded from the same 22 (see FIGS. 2 and 2a).

The device 10 comprises a frame 30 allowed adjustably established the device 10, an anvil 40 and a perforating 50 rollers together providing these apertures 20 in the material 15 an a folding means.

The frame 30 includes two supporting means 32 spaced on a both sides of the drawing material 15.

The anvil roller 40 has a cylindrical outer surface 42 extending substantially the full width across the sheet-like material 15 and a plurality of circumferential grooves 44 disposed along this surface 42 and allowed transiently receiving the flaps 24 into. The anvil roller 40 freely rotating about its longitudinal axle 45, and is connected to the supporting means 32. The continuously drawing material 15 partially encircled by part 16 the outer surface 42 at any time for providing to the anvil roller 40 same speed by virtue of friction developed between them. The outer surface 42 of the anvil roller 40 has been made from high friction materials. Usually it is different kind of the rubber.

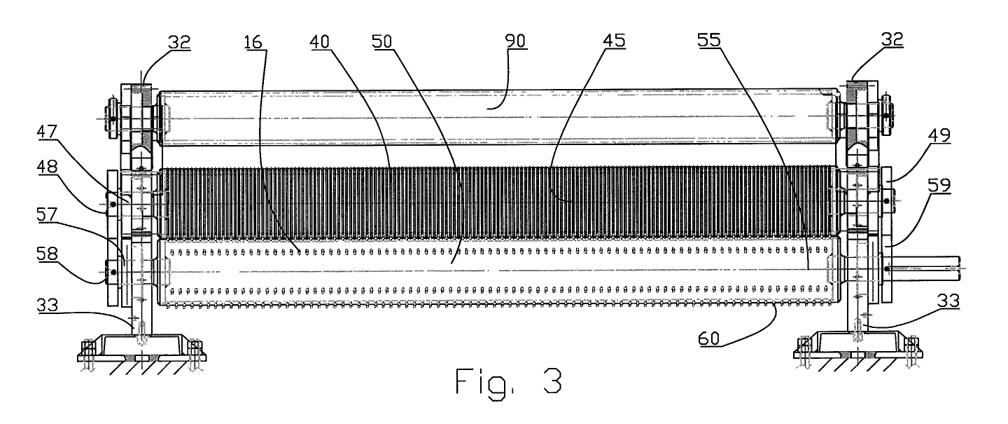

The perforating roller 50 includes (see FIG. 3) a plurality of an adjustable perforating means 60 radially protruding from the same 50 for providing the apertures 20 in the partially encircling continuously drawing between both rollers 40 and 50 sheet-like material 16, usually from border to border of the material 15, with simultaneous deflecting the flaps 24 from the openings 22 into the grooves 44. The perforating roller 50 freely rotates about its longitudinal axle 55 is connected to the supporting means 32 and matching the anvil roller 40 at any time for maintaining the same speed as the anvil roller 40.

There is also a folding means 70 is including in the device 10 and extends substantially the full width across a part 17 of the drawing material 15 outdrawing from the rollers 40 and 50 into the packaging means P. The folding means 70 is adjustably connected to the frame 30 for irrevocable rearwardly folding the deflecting flaps 24.

As is illustrated in FIGS. 1 and 4 at least one of the perforating means 60 is at any time in engagement with a portion 16 of the material 15 partially encircling the outer surface 42 of the anvil roller 40. The perforating means 60 has a free peripherally closed cutting edge 62 adapted for jointly with the groves 44 cuttingly penetrating the material 16 by a front 63 and a both lateral 64 sides of this edge 62 for developing the openings 22 and deflectingly pushing the flaps 24 by a rear side 65 of the same 62 from the openings 22 into the grooves 44. The perforating means 60 is temporarily partially inserted into the groove 44 for assuring the flap 24 entering in the same 44.

Referring to FIG. 3 both of rollers 40 and 50 have an axle journals 47 and 57 are integral to both sides of the rollers 40 and 50 freely rotated into the supporting means 32 and having a free ends 48 and 58 protruding from an external surfaces 33 of the supporting means 32. Each of the free ends 48 and 58 has a gearing means 49 and 59 which are mutually engaged for providing the matching between the rollers 40 and 50.

At least one of the rollers 40 and 50 is adjustably connected to the supporting means 32 via pivoting means 80. FIG. 1 illustrated this pivoting connection of the anvil roller 40. The supporting means 32 has an adjuster 86 for controlling the mutually engaging and allowed to separate said rollers 40 and 50 (as indicated in dotted lines in FIG. 1) for inserting the sheet-like material 15 between them in the beginning of the perforating process. The adjuster 86 is a pneumatic cylinder.

The perforating means 60 is adjustably twisted in the perforating roller 50 via mutual male and female threads 67 (see FIG. 4). This adjusting allowed to set the perforating condition of the device 10.

The folding means 70 includes at least one longitudinal brush 72 extending substantially the full width across the outdrawing material 16.

For a straight type of material 15 the folding means 70 includes at least one longitudinal electrical heater 74 extending substantially the full width across the outdrawing material 17.

The frame 30 includes a directing means 90 extending substantially the full width across the material 15 located between the supply means S and the anvil roller 40 for stabilizing dimension of the partially encircling part 16 of the paper 15. The directing means 90 preferably is a freely rotating cylindrical roller.

With reference to FIGS. 1-4 there is illustrated a method for production a plurality of an apertures 20 in a sheet-like material 15. comprising the steps of:

partially encircling an outer surface 42 of an anvil roller 40 by the continuously drawing material 16 at any time (see FIGS. 3 and 4), this anvil roller 40 has the cylindrical outer surface 42 extending substantially the full width across the sheet-like material 16 and a plurality of circumferential grooves 44 disposed along the surface 42 which allowed transiently receiving the flaps 24 into, the anvil roller 40 freely rotating about its longitudinal axle 45 and is connected to supporting means 32 spaced on a both sides of the drawing material 15, both said supporting means 32 forming a frame 30 allowed adjustably established a perforating device 10;

providing to the anvil roller 40 same speed as the continuously drawing partially encircling the outer surface 32 material 16 by virtue of friction developed between them;

matching the anvil roller 40 with a perforating roller 50 for maintaining by this perforating roller 50 the same speed as the anvil roller 40 at any time (see FIG. 3), the perforating roller 50 includes a plurality of an adjustable perforating means 60 radially protruding from the same 50, at least one of the perforating means 60 is at any time in engagement with a portion 16 of the material 15 partially encircling the outer surface 42 of the anvil roller 50;

providing the apertures 20 (see FIGS. 2 and 4) in the partially encircling continuously drawing between the rollers 40 and 50 sheet-like material 16, usually from border to border of the same 16, with simultaneous deflection of the flaps 24 from the openings 22 into the grooves 44, the perforating roller 50 freely rotating about its longitudinal axle 45 and is connected to the supporting means 32;

folding the deflecting flaps 24 rearwardly and irrevocably by a folding means 70 extending substantially the full width across a part 17 of the drawing material 15 outdrawing from the rollers 40 and 50 into the packaging means P.

This device 10 allowed new apertured sheet material 17 may be produced with uniformly spaced and uniformly sized apertures 20. The perforated sheet material 17 may be produced at great speeds with simple equipment in extremely economical manner.

In our invention all flaps 24 are in a folded position without tending to fall back and cover the opening 22, thus preventing desired porosity of the material 15.

In operation, the folding means 70 bents back flaps 24 for setting in its bent back configuration by a smooth folding action without any shredding of the opening 22.

The heat produced by electrical heater 74 tends to ironingly additionally set the flaps 24 into the bent back configuration.

In term of process technique the perforating device 10 is mounted between the supply means S and the packaging means P. The material 15 is loading into device 10 between the anvil 40 and perforating rollers 50. When the drawing paper is a wide, the anvil roller 40 can be pivoting from the perforating roller 50 by adjuster 86 and, after the paper insertion, can be return by the same 86 for the matching with the perforating roller 50.

The material 50 start to drive through the device 10 from a supply means S to a packaging means P. Both rollers 40 and 50 start to move with a same speed as material 15. Each of the perforating means 60 partially inserted into the groove 44, and mutually produced the plurality of apertures 20 with the stable opening 22 and rearwardly folded flap 24 in the unstopping continuous manufacturing process.

Although the present perforating device for production a plurality of an apertures in a drawing through sheet-like material has been described with a certain degree of particularity it is to be understood that the disclosure has been made by way of example only and that the present invention is not limited to the features of the embodiment(s) described and illustrated herein, but includes all variations and modifications within the scope and spirit of the invention as hereinafter claimed.

I claim:

1. A perforating device for production of a plurality of apertures in a sheet-like material, said material continuously drawing through said device from a supply means to a packaging means, each of said apertures having an opening and a flap adjoining a rear zone of said opening and being rearwardly folded from the same, said device comprising:
a frame allowed adjustably established said device, said frame including two supporting means spaced on a both sides of said drawing material;
an anvil roller having a cylindrical outer surface extending substantially the full width across said sheet-like material and a plurality of circumferential grooves disposed along said surface and allowed transiently receiving said flaps into, said anvil roller freely rotating about its longitudinal axle, and being connected to said supporting means, said continuously drawing material partially encircled said outer surface at any time for providing to said anvil roller same speed by virtue of friction developed between them;
a perforating roller including a plurality of adjustable perforating means radially protruding from the same for providing said apertures in said partially encircling continuously drawing between said rollers sheet-like material, usually from border to border of the same, with simultaneous deflecting said flaps from said openings into said grooves, said perforating roller freely rotating about its longitudinal axle being connected to said supporting means and matching said anvil roller at any time for maintaining the same speed as said anvil roller,
a folding means extending substantially the full width across a part of said drawing material outdrawing from said rollers into said packaging means and being adjustably connected to said frame for irrevocable rearwardly folding said deflecting flaps.

2. The device according to claim 1, wherein at least one of said perforating means being at any time in engagement with a portion of said material partially encircling said outer surface of said anvil roller, said perforating means having a free peripherally closed cutting edge adapted for jointly with said groves cuttingly penetrating said material by a front and a both lateral sides of said edge for developing said openings and deflectingly pushing said flaps by a rear side of the same from said openings into said grooves.

3. The device according to claim 1, wherein said rollers having an axle journals being integral to said rollers freely rotated into said supporting means and having a free ends protruding from an external surfaces of said supporting means, each of free ends having a gearing means mutually engaged for providing said matching between said rollers.

4. The device according to claim 3, wherein at least one of said rollers being adjustably connected to said supporting means via a pivoting means, said supporting means having an adjuster for controlling said mutually engaging and allowed to separate said rollers for inserting said sheet-like material between them in the beginning of said perforating process.

5. The device according to claim 4, wherein said adjuster being a pneumatic cylinder.

6. The device according to claim 1, wherein said perforating means being adjustably twisted in said perforating roller via mutual male and female threads.

7. The device according to claim 1, wherein said folding means including at least one longitudinal brush extending substantially the full width across said outdrawing material.

8. The device according to claim 7, wherein said folding means including at least one longitudinal electrical heater extending substantially the full width across said outdrawing material.

9. The device according to claim 1, wherein said frame including a directing means extending substantially the full width across said material located between said supply means and said anvil roller for stabilizing dimension of said partially encircling.

10. The device according to claim 9, wherein said directing means being a freely rotating cylindrical roller.

11. A method for production of a plurality of apertures in a sheet-like material, said material continuously drawing from a supply means to a packaging means through a perforating device extending substantially the full width across said material, each of said apertures having an opening and a flap adjoining a rear zone of said opening and being rearwardly folded from the same, said method comprising the steps of:
a) partially encircling an outer surface of an anvil roller by said continuously drawing material at any time, said anvil roller having a cylindrical outer surface extending substantially the full width across said sheet-like material and a plurality of circumferential grooves disposed along said surface which allowed transiently receiving said flaps into, said anvil roller freely rotating about its longitudinal axle and being connected to a supporting means spaced on a both sides of said drawing material, both said supporting means forming a frame allowed adjustably established said device;
b) providing to said anvil roller same speed as said continuously drawing partially encircling said outer surface material by virtue of friction developed between them;
c) matching said anvil roller with a perforating roller for maintaining by said perforating roller the same speed as said anvil roller at any time, said perforating roller including a plurality of adjustable perforating means radially protruding from the same, at least one of said perforating means being at any time in engagement with a portion of said material partially encircling said outer surface of said anvil roller;
d) providing said apertures in said partially encircling continuously drawing between said rollers sheet-like material, usually from border to border of the same, with simultaneous deflecting of said flaps from said openings into said grooves, said perforating roller freely rotating about its longitudinal axle and being connected to said supporting means;
e) folding said deflecting flaps rearwardly and irrevocably by a folding means extending substantially the full width across a part of said drawing material outdrawing from said rollers into said packaging means.
